(19) United States
(12) Patent Application Publication
(10) Pub. No.: US 2024/0070485 A1
(43) Pub. Date: Feb. 29, 2024

(54) REINFORCEMENT LEARNING FOR OPTIMIZING CROSS-CHANNEL COMMUNICATIONS

(71) Applicant: Optum, Inc., Minnetonka, MN (US)

(72) Inventors: Jason Edward Weinberg, Galesburg, IL (US); Man Kin Hui, Plano, TX (US)

(21) Appl. No.: 18/168,774

(22) Filed: Feb. 14, 2023

Related U.S. Application Data
(60) Provisional application No. 63/371,552, filed on Aug. 16, 2022.

(51) Int. Cl. G06N 5/022; G06N 20/00

(52) U.S. Cl. CPC G06N 5/022; G06N 20/00

(57) ABSTRACT

Various embodiments of the present disclosure provide methods, apparatus, systems, computing devices, computing entities, and/or the like for performing agent actions using a predictive software agent framework configured to retrieve historical event sequence data, transform, using a state encoder machine learning model, the historical event sequence data into one or more sequence embeddings comprising fixed-length vectors, generate, using a predictive software agent machine learning model, a prediction output comprising one or more optimal agent actions comprising at least a best agent action based on the one or more sequence embeddings.

### CROSS REFERENCE TO RELATED APPLICATION

This application claims the priority of U.S. Provisional Application No. 63/371,552, entitled “Autonomous Learning Agent Driven Multichannel Offers and Calls to Action,” filed on Aug. 16, 2022, the disclosure of which is hereby incorporated by reference in its entirety.

### BACKGROUND

Various embodiments of the present disclosure address technical challenges related to performing predictive data analysis for generating various forms of electronic communications and provide solutions to address the efficiency and reliability shortcomings of existing predictive data analysis solutions.

### BRIEF SUMMARY

In general, various embodiments of the present disclosure provide methods, apparatus, systems, computing devices, computing entities, and/or the like for reducing low value and unwanted agent actions to improve quality of service and reduce communication fatigue.

In some embodiments, a computer-implemented method comprises: receiving, by one or more processors, an agent action query comprising an entity identifier and one or more Boolean flags; receiving, by the one or more processors, historical event sequence data associated with the entity identifier, wherein the historical event sequence data comprises state representation data, agent action data, and agent interaction data; transforming, by the one or more processors and using a state encoder machine learning model, the historical event sequence data into one or more sequence embeddings comprising fixed-length vectors; generating, by the one or more processors and using a predictive software agent machine learning model, a prediction output comprising one or more optimal agent actions comprising at least a best agent action based on the one or more sequence embeddings and the one or more Boolean flags, wherein: (i) the best agent action comprises a highest-scoring action, (ii) the highest-scoring action is determined from an action distribution based on an action reward value associated with the highest-scoring action, (iii) the predictive software agent machine learning model is trained over one or more training intervals by: (a) retrieving training agent interaction data comprising one or more training agent interactions associated with respective one or more training agent actions, the training agent interaction data recorded over a selected period of time for a respective training interval, (b) generating an action reward value for each of the one or more training agent interactions by applying a reward function to the one or more training agent interactions, (c) for each of one or more target ones of client computing entities, combining selected ones of the one or more training agent interactions associated with a target client computing entity into a historical episode, (d) storing the historical episode to a historical database comprising a plurality of historical episodes, (e) generating a plurality of historical episode combinations, each of the plurality of historical episode combinations comprising N historical episodes and at least one most recent historical episode selected from the plurality of historical episodes, and (f) determining one or more of the plurality of historical episode combinations associated with optimal model parameters; and initiating, by the one or more processors, the performance of the one or more optimal agent actions.

In some embodiments, a computing apparatus comprising memory and one or more processors communicatively coupled to the memory, the one or more processors configured to: receive an agent action query comprising an entity identifier and one or more Boolean flags; receive historical event sequence data associated with the entity identifier, wherein the historical event sequence data comprises state representation data, agent action data, and agent interaction data; transform, using a state encoder machine learning model, the historical event sequence data into one or more sequence embeddings comprising fixed-length vectors; generate, using a predictive software agent machine learning model, a prediction output comprising one or more optimal agent actions comprising at least a best agent action based on the one or more sequence embeddings and the one or more Boolean flags, wherein: (i) the best agent action comprises a highest-scoring action, (ii) the highest-scoring action is determined from an action distribution based on an action reward value associated with the highest-scoring action, (iii) the predictive software agent machine learning model is trained over one or more training intervals by: (a) retrieving training agent interaction data comprising one or more training agent interactions associated with respective one or more training agent actions, the training agent interaction data recorded over a selected period of time for a respective training interval, (b) generating an action reward value for each of the one or more training agent interactions by applying a reward function to the one or more training agent interactions, (c) for each of one or more target ones of client computing entities, combining selected ones of the one or more training agent interactions associated with the entity into a historical episode, (d) storing the historical episode to a historical database comprising a plurality of historical episodes, (e) generating a plurality of historical episode combinations, each of the plurality of historical episode combinations comprising N historical episodes and at least one most recent historical episode selected from the plurality of historical episodes, and (f) determining one or more of the plurality of historical episode combinations associated with optimal model parameters; and initiate the performance of the one or more optimal agent actions.

In some embodiments, one or more non-transitory computer-readable storage media including instructions that, when executed by one or more processors, cause the one or more processors to: receive an agent action query comprising an entity identifier and one or more Boolean flags; receive historical event sequence data associated with the entity identifier, wherein the historical event sequence data comprises state representation data, agent action data, and agent interaction data; transform, using a state encoder machine learning model, the historical event sequence data into one or more sequence embeddings comprising fixed-length vectors; generate, using a predictive software agent machine learning model, a prediction output comprising one or more optimal agent actions comprising at least a best agent action based on the one or more sequence embeddings and the one or more Boolean flags, wherein: (i) the best agent action comprises a highest-scoring action, (ii) the highest-scoring action is determined from an action distribution based on an action reward value associated with the highest-scoring action, (iii) the predictive software agent machine learning model is trained over one or more training intervals by: (a) retrieving training agent interaction data comprising one or more training agent interactions associated with respective one or more training agent actions, the training agent interaction data recorded over a selected period of time for a respective training interval, (b) generating an action reward value for each of the one or more training agent interactions by applying a reward function to the one or more training agent interactions, (c) for each of one or more target ones of client computing entities, combining selected ones of the one or more training agent interactions associated with the entity into a historical episode, (d) storing the historical episode to a historical database comprising a plurality of historical episodes, (e) generating a plurality of historical episode combinations, each of the plurality of historical episode combinations comprising N historical episodes and at least one most recent historical episode selected from the plurality of historical episodes, and (f) determining one or more of the plurality of historical episode combinations associated with optimal model parameters; and initiate the performance of the one or more optimal agent actions.

### BRIEF DESCRIPTION OF THE DRAWINGS

FIG. 1 provides an example overview of an architecture in accordance with some embodiments of the present disclosure.

FIG. 2 provides an example predictive data analysis computing entity in accordance with some embodiments of the present disclosure.

FIG. 3 provides an example client computing entity in accordance with some embodiments of the present disclosure.

FIG. 4 is a flowchart diagram of an example process for performing predictive operations in accordance with some embodiments of the present disclosure.

FIG. 5 provides an operational example of a predictive machine learning model framework in accordance with some embodiments discussed herein.

FIG. 6 is a flowchart diagram of an example process for training a predictive software agent machine learning model in accordance with some embodiments discussed herein.

FIG. 7 is a flowchart diagram of an example process for generating historical episodes in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. COMPUTER PROGRAM PRODUCTS, METHODS, AND COMPUTING ENTITIES

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

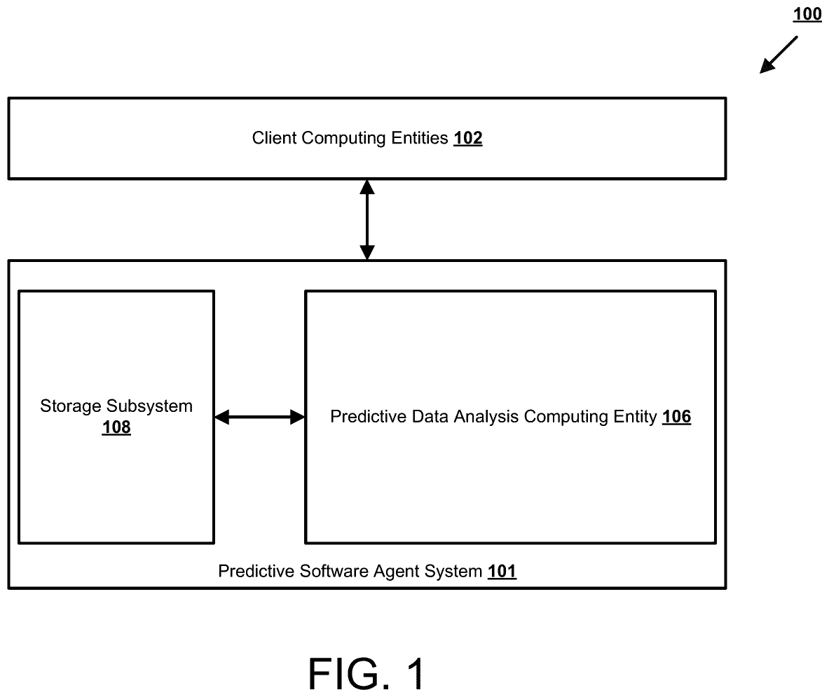

FIG. 1 is a schematic diagram of an example architecture 100 for performing predictive data analysis. The architecture 100 includes a predictive software agent system 101 configured to receive predictive data analysis requests from client computing entities 102, process the predictive data analysis requests to generate predictions, provide the generated predictions to the client computing entities 102, and automatically initiate performance of one or more prediction-based actions based on the generated predictions.

An example of a prediction-based action that can be performed using the predictive software agent system 101 comprises receiving an agent action query comprising an entity identifier and one or more Boolean flags, generating a prediction output comprising one or more optimal agent actions, and performing at least one of the one or more optimal agent actions, e.g., using one or more communication channels (e.g., web, mobile, telephone, IVR, email, SMS, in-app messaging) to facilitate contact with, for example, client computing entities 102. Other examples of prediction-based actions comprise generating a diagnostic report, displaying/providing resources, generating action scripts, or generating alerts or reminders based on the prediction output.

In accordance with various embodiments of the present disclosure, unwanted agent agents may be reduced by training a predictive software agent machine learning model to predict one or more optimal agent actions to be performed by predictive software agent system 101. The one or more optimal agent actions may be predicted by maximizing action reward values of selected agent actions based on one or more sequence embeddings and a reward function. Accordingly, the disclosed predictive software agent may reduce the number of ineffective agent actions and maximize benefit to recipients (e.g., client computing entities 102) of the agent actions. This technique will lead to higher accuracy of performing predictive operations by predictive software agent system 101 as needed. In doing so, the techniques described herein improve efficiency and speed of training predictive machine learning models, thus reducing the number of computational operations needed and/or the amount of training data entries needed to train predictive machine learning models. Accordingly, the techniques described herein improve the computational efficiency, storage-wise efficiency, and/or speed of training predictive machine learning models.

In some embodiments, predictive software agent system 101 may communicate with at least one of the client computing entities 102 through one or more communication channels using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The predictive software agent system 101 may include a predictive data analysis computing entity 106 and a storage subsystem 108. The predictive data analysis computing entity 106 may be configured to receive predictive data analysis requests from one or more client computing entities 102, process the predictive data analysis requests to generate predictions corresponding to the predictive data analysis requests, provide the generated predictions to the client computing entities 102, and automatically initiate performance of one or more prediction-based actions based on the generated predictions.

The storage subsystem 108 may be configured to store input data used by the predictive data analysis computing entity 106 to perform predictive data analysis as well as model definition data used by the predictive data analysis computing entity 106 to perform various predictive data analysis tasks. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### A. Example Predictive Data Analysis Computing Entity

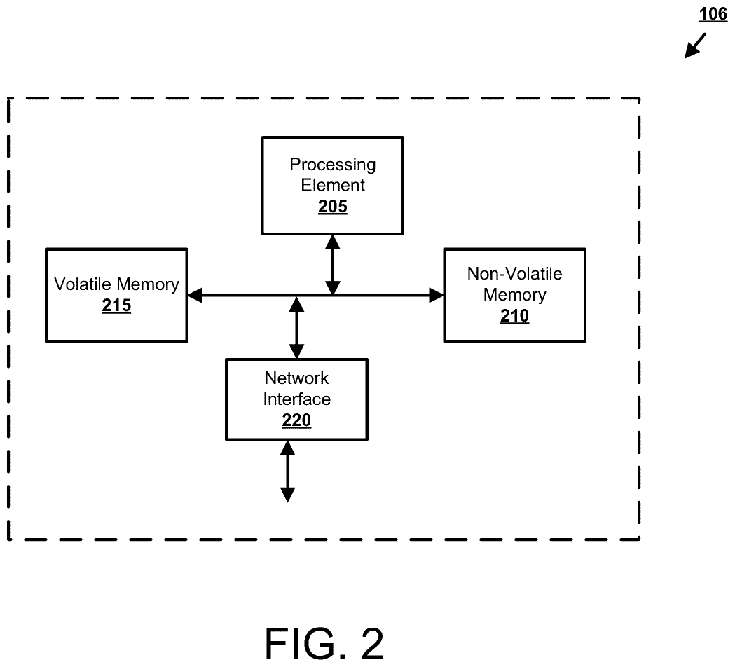

FIG. 2 provides a schematic of a predictive data analysis computing entity 106 according to some embodiments of the present disclosure. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In some embodiments, these functions, operations, and/or processes can be performed on data, content, information, and/or similar terms used herein interchangeably.

As indicated, in some embodiments, the predictive data analysis computing entity 106 may also include one or more network interfaces 220 for communicating with various computing entities, such as by communicating data, content, information, and/or similar terms used herein interchangeably that can be transmitted, received, operated on, processed, displayed, stored, and/or the like.

As shown in FIG. 2, in some embodiments, the predictive data analysis computing entity 106 may include, or be in communication with, one or more processing elements 205 (also referred to as processors, processing circuitry, and/or similar terms used herein interchangeably) that communicate with other elements within the predictive data analysis computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the predictive data analysis computing entity 106 may further include, or be in communication with, non-volatile media (also referred to as non-volatile storage, memory, memory storage, memory circuitry and/or similar terms used herein interchangeably). In some embodiments, the non-volatile storage or memory may include one or more non-volatile memory 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FIG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In some embodiments, the predictive data analysis computing entity 106 may further include, or be in communication with, volatile media (also referred to as volatile storage, memory, memory storage, memory circuitry and/or similar terms used herein interchangeably). In some embodiments, the volatile storage or memory may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the predictive data analysis computing entity 106 with the assistance of the processing element 205 and operating system.

As indicated, in some embodiments, the predictive data analysis computing entity 106 may also include one or more network interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the predictive data analysis computing entity 106 may include, or be in communication with, one or more input elements, such as a keyboard input, a mouse input, a touch screen/display input, motion input, movement input, audio input, pointing device input, joystick input, keypad input, and/or the like. The predictive data analysis computing entity 106 may also include, or be in communication with, one or more output elements (not shown), such as audio output, video output, screen/display output, motion output, movement output, and/or the like.

### B. Example Client Computing Entity

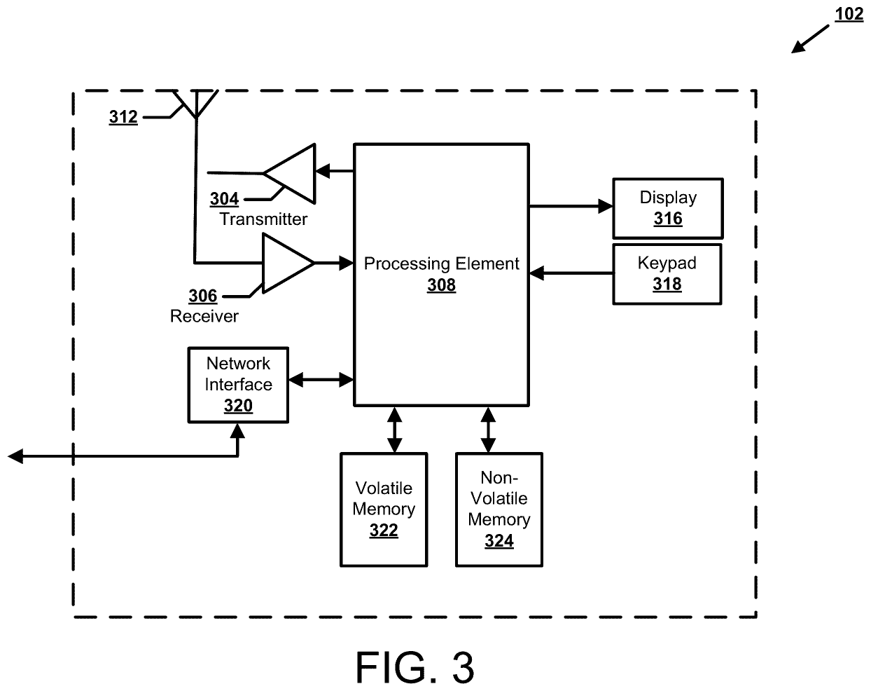

FIG. 3 provides an illustrative schematic representative of a client computing entity 102 that can be used in conjunction with embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 can be operated by various parties. As shown in FIG. 3, the client computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the predictive data analysis computing entity 106. In some embodiments, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the predictive data analysis computing entity 106 via a network interface 320.

Via these communication standards and protocols, the client computing entity 102 can communicate with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 can also download changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In some embodiments, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the position of the client computing entity 102 in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The client computing entity 102 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the predictive data analysis computing entity 106, as described herein. The user input interface can comprise any of a number of devices or interfaces allowing the client computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The client computing entity 102 can also include volatile memory 322 and/or non-volatile memory 324, which can be embedded and/or may be removable. For example, the non-volatile memory 324 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory 322 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory can store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the entity or accessible through a browser or other user interface for communicating with the predictive data analysis computing entity 106 and/or various other computing entities.

In another embodiment, the client computing entity 102 may include one or more components or functionality that are the same or similar to those of the predictive data analysis computing entity 106, as described in greater detail above. As will be recognized, these architectures and descriptions are provided for example purposes only and are not limiting to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### III. EXAMPLES OF CERTAIN TERMS

In some embodiments, the term “historical event sequence data” may refer to a data construct that describes a temporal sequence of state representation data, agent action data, and agent interaction data. For example, historical event sequence data comprises sequentially relevant ones of one or more states of a target one of client computing entities 102, one or more agent actions performed by predictive software agent system 101 towards the target one of client computing entities 102, one or more agent interactions between predictive software agent system 101 and the target one of client computing entities 102, and one or more reward values. In some embodiments, historical event sequence data may be transformed into one or more sequence embeddings and a prediction output comprising one or more optimal agent actions to be performed by a predictive software agent system may be generated based on the one or more sequence embeddings.

In some embodiments, the term “state representation data” may refer to a data construct that describes a feature representation associated with a client computing entity 102. In some embodiments, state representation data may comprise characteristics of a client computing entity 102. For example, state representation data may comprise device type, device specification, device location, and communication channel capability (e.g., web, mobile application, phone, email, or SMS). In another example, state representation data may comprise characteristics of a user associated with a client computing entity 102, such as demographics, social determinants, communication channel usage or preference, and medical history of a user.

In some embodiments, the term “agent interaction data” may refer to a data construct that describes one or more agent interactions, such as a transaction, activity, or communication between a predictive software agent system 101 and a client computing entity 102. In some embodiments, an agent interaction may comprise an action performed by a client computing entity 102 in response to an agent action. Examples of agent interactions may include an interaction via a webpage, web application or interface, electronic communication or messaging (e.g., email, SMS), IVR system, phone systems, or any other types of communication channels controlled by or communicatively coupled to predictive software agent system 101. In some embodiments, an agent interaction may comprise an instance of a communication attempt associated with predictive software agent system 101 to a client computing entity 102 and response to the communication attempt from the client computing entity 102 (e.g., accepted/succeeded/failed).

In some embodiments, the term “agent action data” may refer to a data construct that describes one or more agent actions performed by a predictive software agent system 101 comprising an alert, offer, solicitation, communication, or call to action to a client computing entity 102. For example, an agent action may comprise a predictive software agent system 101 using one or more communication channels (e.g., web, mobile, telephone, IVR, email, SMS, in-app messaging) to facilitate contact with a client computing entity 102.

In some embodiments, the term “training agent interaction data” may refer to a data construct that describes one or more agent interactions, such as a transaction, activity, or communication between predictive software agent system 101 and a client computing entity 102 that is used to train a predictive software agent machine learning model. For example, a training agent interaction may comprise an action performed by a client computing entity 102 in response to an agent action during a selected period of time. Training agent interaction data may be collected over selected periods of time for respective training intervals.

In some embodiments, the term “state encoder machine learning model” may refer to a data construct that describes parameters, hyperparameters, and/or defined operations of a machine learning model that is configured to transform historical event sequence data comprising data elements (e.g., state representation data, agent action data, and/or agent interaction data) of variable lengths into one or more sequence embeddings. In some embodiments, a state encoder machine learning model may receive historical event sequence data in a tokenized state and normalize the tokenized historical event sequence data. Historical event sequence data may be tokenized by converting data elements of the historical event sequence data comprising, e.g., state representation data, agent action data, and agent interaction data, and converting the data elements into unique identifiers (such as integers and/or characters). The tokenized historical event sequence data may be normalized by transforming the tokenized historical event sequence data into fixed length vectors (e.g., sequence embeddings). As such, the state encoder machine learning model may convert historical event sequence data into fixed length vectors that are usable/suitable as input by a predictive software agent machine learning model, which may require input of a certain format and/or size.

In some embodiments, the term “sequence embedding” may refer to a data construct that describes a mathematical representation of historical event sequence data generated by a state encoder machine learning model. For example, a sequence embedding may comprise fixed-length vectors. A sequence embedding may be provided as input to a machine learning model, such as a predictive software agent machine learning model. In some embodiments, a sequence embedding may be used by a predictive software agent machine learning model to estimate a preference or inclination for a client computing entity 102 to be receptive to an agent action by generating action reward values based on a reward function.

In some embodiments, the term “action reward value” may refer to a data construct that describes a numerical output representative of a reward or penalty associated with an agent action performed by a predictive software agent system 101. In some embodiments, the action reward value may be used to train a predictive software agent machine learning model to predict optimal agent actions. An action reward value may be positive or negative. In some embodiments, a predictive software agent machine learning model may be configured to generate predictions of one or more optimal agent actions by maximizing action reward values of selected agent actions.

In some embodiments, the term “reward function” may refer to a data construct that describes an operation that may be used to generate an action reward value for an agent action during training intervals. A reward function may generate action reward values based on one or more agent interactions between predictive software agent system 101 and a target one of client computing entities 102. For example, a reward function may generate: a penalty (e.g., −1) for every time client computing entity 102 calls into an IVR following an agent action by predictive software agent system 101, a reward (e.g., +1) for every agent action by the predictive software agent system 101 that is accepted and completed with respect to a client computing entity 102, and a penalty (e.g., −1) for every agent action by the predictive software agent system 101 client computing entity 102 denies. In some embodiments, a predictive software agent machine learning model may be configured to maximize action reward values generated by the reward function.

In some embodiments, the term “action distribution” may refer to a data construct that describes a set of one or more agent actions and action reward values for each of the one or more agent actions. An action distribution may be generated for each client computing entity 102 (or user of client computing entity 102). For example, an action distribution may comprise an action reward value or each agent action taken. In some embodiments, an action distribution may be updated upon each training interval by updating action reward values of agent actions in the action distribution corresponding to one or more training agent interactions associated with one or more respective training agent actions (e.g., from training agent interaction data) collected over a selected period of time for a respective training interval. A prediction of one or more optimal agent actions generated by a predictive software agent machine learning model may be based on maximizing actions from an action distribution that are predicted to result in high future discounted reward values. For example, a prediction of one or more optimal agent actions may comprise at least one best agent action selected by a predictive software agent machine learning model from the action distribution based on a determination that the best agent action is associated with or predicted to return a highest action reward value.

In some embodiments, the term “predictive software agent machine learning model” may refer to a data construct that describes parameters, hyperparameters, and/or defined operations of a machine learning model that is configured to generate a prediction output comprising one or more optimal agent actions based on historical event sequence data, a reward function, and one or more Boolean flags. The one or more optimal agent actions may comprise a highest-scoring action (best agent action) determined from an action distribution based on an action reward value of the highest-scoring action generated by the reward function. In some embodiments, the predictive software agent machine learning model comprises a reinforcement learning machine learning model. In some embodiments, the predictive software agent machine learning model may be trained over one or more training intervals by: (a) retrieving training agent interaction data comprising one or more training agent interactions associated with respective one or more training agent actions, the training agent interaction data recorded over a selected period of time for a respective training interval, (b) generating an action reward value for each of the one or more training agent interactions by applying a reward function to the one or more training agent interactions, (c) for each of one or more target ones of client computing entities 102, combining selected ones of the one or more training agent interactions associated with a target one of client computing entities 102 into a historical episode, (d) storing the historical episode to a historical database comprising a plurality of historical episodes, (e) generating a plurality of historical episode combinations, each of the plurality of historical episode combinations comprising N historical episodes and at least one most recent historical episode selected from the plurality of historical episodes, and (f) determining one or more of the plurality of historical episode combinations associated with optimal model parameters.

In some embodiments, the term “reinforcement learning machine learning model” may refer to a data construct that describes parameters, hyperparameters, and/or defined operations of a machine learning model that is configured to optimize a reward function over time. In some embodiments, a reinforcement learning machine learning model may comprise Markov decision processes for maximizing action reward values of agent actions based on historical event sequence data. A reinforcement learning machine learning model may determine a state associated with client computing entity 102 based on historical event sequence data, select an agent action (e.g., from one or more optimal agent actions) to perform, and receive a reward (e.g., action reward value) via a reward function, and iteratively predict likely one or more next states and one or more next agent actions. In some embodiments, a reinforcement learning machine learning model may comprise a deep Q network. A deep Q network may comprise a neural network used to learn and perform a sequence of agent actions to maximize a reward function, and may include exploration and exploitation phases for instructing predictive software agent system 101 to select and perform agent actions. For example, an exploration phase may test certain agent actions (that do not necessarily include the best agent action) at certain time periods for given ones of client computing entities 102 that may not have sufficient historical event sequence data collected for (e.g., not enough agent interactions in the historical event sequence data), while an exploitation phase may select agent actions (e.g., best agent actions) that are proven to generate a positive reward based on historical event sequence data.

In some embodiments, the term “Boolean flag” may refer to a data construct that describes a criterion that may be used to limit or filter certain agent actions to be selected for performance. For example, a Boolean flag may filter one or more agent actions from an action distribution from which predictive software agent system 101 selects agent actions from to perform.

### IV. OVERVIEW, TECHNICAL IMPROVEMENTS, AND TECHNICAL ADVANTAGES

Various embodiments of the present disclosure make important technical contributions to improving predictive accuracy of predictive software agent machine learning models comprising a reinforcement learning machine learning model by predicting optimal agent actions based on future discounted action reward values. This approach improves training speed and training efficiency of training predictive software agent machine learning models. It is well-understood in the relevant art that there is typically a tradeoff between predictive accuracy and training speed, such that it is trivial to improve training speed by reducing predictive accuracy. Thus the real challenge is to improve training speed without sacrificing predictive accuracy through innovative model architectures. Accordingly, techniques that improve predictive accuracy without harming training speed, such as the techniques described herein, enable improving training speed given a constant predictive accuracy. In doing so, the techniques described herein improve efficiency and speed of training predictive software agent machine learning models, thus reducing the number of computational operations needed and/or the amount of training data entries needed to train predictive software agent machine learning models. Accordingly, the techniques described herein improve the computational efficiency, storage-wise efficiency, and/or speed of training machine learning models.

For example, various embodiments of the present disclosure improve predictive accuracy of predictive software agent machine learning models by maximizing a reward function over time based on historically collected data. As described herein, fragmented ecosystems that generate alerts, offers, messages, emails, phone calls and other forms of communications that all target a same one of client computing entities 102 are typically based on segmentation, rule-based logics and/or propensity score matching which focus on correlations derived from historical experiences of client computing entities 102 who responded to alerts and offers. Such fragmented ecosystems lead to excessive communications that lead to alert fatigue and disengagement with other future, important communications. Furthermore, these types of communications are created in siloes inside each individual application, leading to a fragmented experience by the client computing entities 102.

However, in accordance with various embodiments of the present disclosure, unwanted agent agents may be reduced by training a predictive software agent machine learning model to predict one or more optimal agent actions to be performed by predictive software agent system 101. The one or more optimal agent actions may be predicted by maximizing action reward values of selected agent actions based on one or more sequence embeddings and a reward function. Accordingly, the disclosed predictive software agent machine learning model may reduce the number of ineffective agent actions and maximize benefit to recipients (e.g., client computing entities 102) of the agent actions. This technique will lead to higher accuracy of performing predictive operations by the predictive software agent system 101 as needed. In doing so, the techniques described herein improve efficiency and speed of training predictive machine learning models, thus reducing the number of computational operations needed and/or the amount of training data entries needed to train predictive machine learning models. Accordingly, the techniques described herein improve the computational efficiency, storage-wise efficiency, and/or speed of training predictive machine learning models.

### V. EXAMPLE SYSTEM OPERATIONS

As indicated, various embodiments of the present disclosure make important technical contributions to improving predictive accuracy of predictive software agent machine learning models comprising a reinforcement learning machine learning model configured to reduce actions performed by predictive software agent system 101. In particular, a predictive software agent machine learning model is disclosed herewith capable of determining a state associated with client computing entity 102, an action to perform based on the state, receive a reward, and make predictions of likely next states and corresponding actions to perform based on predicted future discounted rewards. As such, the disclosed predictive software agent machine learning model is configured to operate with an objective of maximizing an amount of reward it receives, via a reward function, and avoids causing states that may contribute to lower reward values. In some embodiments, the predictive software agent machine learning model may comprise a reinforcement learning machine learning model that is trained to determine what agent action to perform with respect to a given one of client computing entities 102 at a given time and communication channel in a manner that prevents duplicative and extraneous agent actions. In some embodiments, the disclosed predictive software agent machine learning model may adapt to new scenarios based on agent actions and interactions such that it may continuously learn to generate agent actions that are beneficial to client computing entities 102, which may be determined based on a reward function.

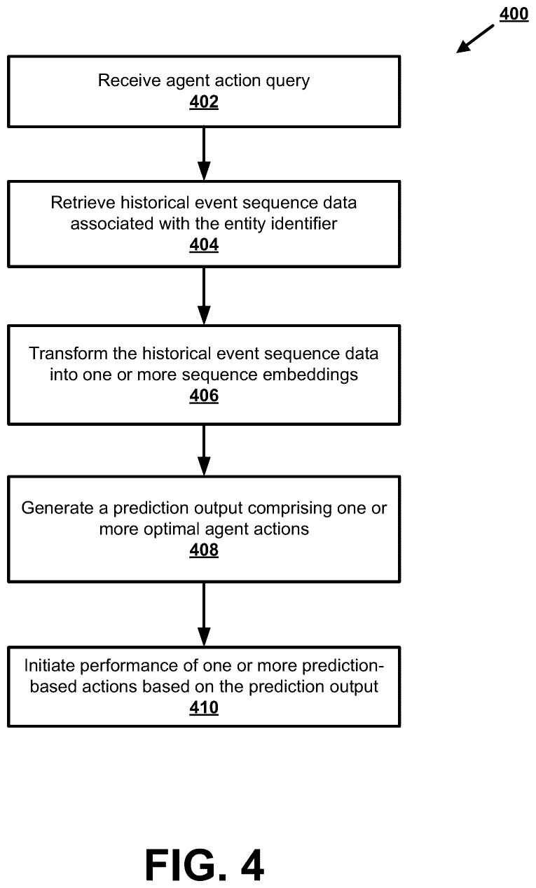

FIG. 4 is a flowchart diagram of an example process 400 for performing predictive operations on an input query associated with one or more agent actions towards a target one of client computing entities, such as a given one of client computing entities 102. In some embodiments, via the various steps/operations of the process 400, the predictive data analysis computing entity 106 may use a predictive machine learning model framework comprising at least a state encoder machine learning model and a predictive software agent machine learning model to generate a prediction output comprising one or more optimal agent actions and initiating performance of the one or more optimal agent actions by predictive software agent system 101.

In some embodiments, the process 400 begins at step/operation 402 when the predictive data analysis computing entity 106 receives an agent action query comprising an entity identifier and one or more Boolean flags. The agent action query may be, for example, generated on a periodic basis (e.g., for every given time period), on an event basis (e.g., in response to an occurrence of an event associated with a target one of client computing entities 102), or on a basis determined by the predictive software agent system 101 of when one or more agent actions should be performed towards a given one of client computing entities 102 associated with an entity associated with the entity identifier.

In some embodiments, a Boolean flag describes a criterion that is provided along with an agent action query to limit or filter certain agent actions to be selected for performance by predictive software agent system 101. For example, a Boolean flag may filter one or more agent actions from an action distribution from which predictive software agent system 101 selects agent actions from to perform.

In some embodiments, at step/operation 404, the predictive data analysis computing entity 106 retrieves historical event sequence data associated with the entity identifier. In some embodiments, historical event sequence data describes a temporal sequence of state representation data, agent action data, and agent interaction data. For example, historical event sequence data comprises sequentially relevant ones of one or more states of a target one of client computing entities 102, one or more agent actions performed by predictive software agent system 101 towards the target one of client computing entities 102, one or more agent interactions between predictive software agent system 101 and the target one of client computing entities 102, and one or more reward values. In some embodiments, historical event sequence data may be transformed into one or more sequence embeddings and a prediction output comprising one or more optimal agent actions to be performed by a predictive software agent system may be generated based on the one or more sequence embeddings.

In some embodiments, state representation data describes a feature representation associated with a client computing entity 102. In some embodiments, state representation data may comprise characteristics of a client computing entity 102. For example, state representation data may comprise device type, device specification, device location, and communication channel capability (e.g., web, mobile application, phone, email, or SMS). In another example, state representation data may comprise characteristics of a user associated with a client computing entity 102, such as demographics, social determinants, communication channel usage or preference, and medical history of a user.

In some embodiments, agent action data describes one or more agent actions performed by a predictive software agent system 101 comprising an alert, offer, solicitation, communication, or call to action to a client computing entity 102. For example, an agent action may comprise a predictive software agent system 101 using one or more communication channels (e.g., web, mobile, telephone, IVR, email, SMS, in-app messaging) to facilitate contact with a client computing entity 102.

In some embodiments, agent interaction data describes one or more agent interactions, such as a transaction, activity, or communication between a predictive software agent system 101 and a client computing entity 102. In some embodiments, an agent interaction may comprise an action performed by a client computing entity 102 in response to an agent action. Examples of agent interactions may include an interaction via a webpage, web application or interface, electronic communication or messaging (e.g., email, SMS), IVR system, phone systems, or any other types of communication channels controlled by or communicatively coupled to predictive software agent system 101. In some embodiments, an agent interaction may comprise an instance of a communication attempt associated with predictive software agent system 101 to a client computing entity 102 and response to the communication attempt from the client computing entity 102 (e.g., accepted/succeeded/failed).

In some embodiments, at step/operation 406, the predictive data analysis computing entity 106 transforms, using a state encoder machine learning model, the historical event sequence data into one or more sequence embeddings. In some embodiments, a state encoder machine learning model describes parameters, hyperparameters, and/or defined operations of a machine learning model that is configured to transform historical event sequence data comprising data elements (e.g., state representation data, agent action data, and/or agent interaction data) of variable lengths into one or more sequence embeddings. In some embodiments, a state encoder machine learning model may receive historical event sequence data in a tokenized state and normalize the tokenized historical event sequence data. Historical event sequence data may be tokenized by converting data elements of the historical event sequence data comprising, e.g., state representation data, agent action data, and agent interaction data, and converting the data elements into unique identifiers (such as integers and/or characters). The tokenized historical event sequence data may be normalized by transforming the tokenized historical event sequence data into fixed length vectors (e.g., sequence embeddings). As such, the state encoder machine learning model may convert historical event sequence data into fixed length vectors that are usable/suitable as input by a predictive software agent machine learning model, which may require input of a certain format and/or size.

In some embodiments, a sequence embedding describes a mathematical representation of historical event sequence data generated by a state encoder machine learning model. For example, a sequence embedding may comprise fixed-length vectors. A sequence embedding may be provided as input to a machine learning model, such as a predictive software agent machine learning model. In some embodiments, a sequence embedding may be used by a predictive software agent machine learning model to estimate a preference or inclination for a client computing entity 102 to be receptive to an agent action by generating action reward values based on a reward function.

In some embodiments, at step/operation 408, the predictive data analysis computing entity 106 generates, using a predictive software agent machine learning model, a prediction output comprising one or more optimal agent actions based on the one or more sequence embeddings and the one or more Boolean flags. The one or more optimal agent actions may comprise at least a best agent action. The best agent action may comprise a highest-scoring action determined from an action distribution based on an action reward value associated with the highest-scoring action.

In some embodiments, an action distribution describes a set of one or more agent actions and action reward values for each of the one or more agent actions. An action distribution may be generated for each client computing entity 102 (or user of client computing entity 102). For example, an action distribution may comprise an action reward value or each agent action taken. In some embodiments, an action distribution may be updated upon each training interval by updating action reward values of agent actions in the action distribution corresponding to one or more training agent interactions associated with one or more respective training agent actions collected (e.g., from training agent interaction data) over a selected period of time for a respective training interval. A prediction of one or more optimal agent actions generated by a predictive software agent machine learning model may be based on maximizing actions from an action distribution that are predicted to result in high future discounted reward values. For example, a prediction of one or more optimal agent actions may comprise at least one best agent action selected by a predictive software agent machine learning model from the action distribution based on a determination that the best agent action is associated with or predicted to return a highest action reward value.

In some embodiments, an action reward value describes a numerical output representative of a reward or penalty associated with an agent action performed by a predictive software agent system 101. In some embodiments, the action reward value may be used to train a predictive software agent machine learning model to predict optimal agent actions. An action reward value may be positive or negative. In some embodiments, a predictive software agent machine learning model may be configured to generate predictions of one or more optimal agent actions by maximizing action reward values of selected agent actions.

In some embodiments, the predictive software agent machine learning model is trained over one or more training intervals by: (a) retrieving training agent interaction data comprising one or more training agent interactions associated with respective one or more training agent actions, the training agent interaction data recorded over a selected period of time for a respective training interval, (b) generating an action reward value for each of the one or more training agent interactions by applying a reward function to the one or more training agent interactions, (c) for each of one or more target ones of client computing entities 102, combining selected ones of the one or more training agent interactions associated with a target one of client computing entities 102 into a historical episode, (d) storing the historical episode to a historical database comprising a plurality of historical episodes, (e) generating a plurality of historical episode combinations, each of the plurality of historical episode combinations N historical episodes and at least one most recent historical episode selected from the plurality of historical episodes, and (f) determining one or more of the plurality of historical episode combinations associated with optimal model parameters.

In some embodiments, the predictive software agent machine learning model comprises a reinforcement learning machine learning model. A reinforcement learning machine learning model may describe parameters, hyperparameters, and/or defined operations of a machine learning model that is configured to optimize a reward function over time. In some embodiments, a reinforcement learning machine learning model may comprise Markov decision processes for maximizing action reward values of agent actions based on historical event sequence data. A reinforcement learning machine learning model may determine a state associated with client computing entity 102 based on historical event sequence data, select an agent action (e.g., from one or more optimal agent actions) to perform, and receive a reward (e.g., action reward value) via a reward function, and iteratively predict likely one or more next states and one or more next agent actions.

In some embodiments, a reward function describes an operation that is used to generate an action reward value for an agent action during training intervals. A reward function may generate action reward values based on one or more agent interactions between predictive software agent system 101 and a target one of client computing entities 102. For example, a reward function may generate: a penalty (e.g., −1) for every time client computing entity 102 calls into an IVR following an agent action by predictive software agent system 101, a reward (e.g., +1) for every agent action by the predictive software agent system 101 that is accepted and completed with respect to a client computing entity 102, and a penalty (e.g., −1) for every agent action by the predictive software agent system 101 client computing entity 102 denies. In some embodiments, a predictive software agent machine learning model may be configured to maximize action reward values generated by the reward function.

In some embodiments, a reinforcement learning machine learning model comprises a deep Q network. A deep Q network may comprise a neural network used to learn and perform a sequence of agent actions to maximize a reward function, and may include exploration and exploitation phases for instructing predictive software agent system 101 to select and perform agent actions. For example, an exploration phase may test certain agent actions (that do not necessarily include the best agent action) at certain time periods for given ones of client computing entities 102 that may not have sufficient historical event sequence data collected (e.g., not enough agent interactions in the historical event sequence data), while an exploitation phase may select agent actions (e.g., best agent actions) that are proven to generate a positive reward based on historical event sequence data.

In some embodiments, the predictive software agent machine learning model comprises a model-free offline learning deep Q network. The model-free offline learning deep Q network may use real experiences from agent interaction data from logged batches of data generated during the real experiences to model state transition based on a given agent action and current state representation data. A model-free offline learning deep Q network may be suitable for learning outcomes of agent actions that never been performed before and hence a result of such agent actions cannot be learned from historical data. A model-free offline learning deep Q network may also be implemented off-policy. For example, off-policy may comprise generating predictions based on previously trained learning. The disclosed model-free offline learning deep Q network may comprise an algorithm, such as Algorithm 1 with reference to the Appendix.

In some embodiments, at step/operation 410, the predictive data analysis computing entity 106 initiates performance of the one or more optimal agent actions. The one or more agent actions may comprise generating electronically, an alert, offer, solicitation, message, communication, or call to action to a client computing entity 102. For example, initiating performance of an optimal agent action may comprise directing a predictive software agent system 101 facilitate contact with a client computing entity 102 by using a given one of a plurality of communication channels (e.g., web, mobile, telephone, IVR, email, SMS, in-app messaging). Initiating the performance of the one or more optimal agent actions may further comprise, for example, performing a resource-based action (e.g., allocation of resource), generating a diagnostic report, generating action scripts, displaying visual renderings of the aforementioned examples of optimal agent actions in addition to values, charts, and representations associated with the optimal agent actions using a prediction output user interface.

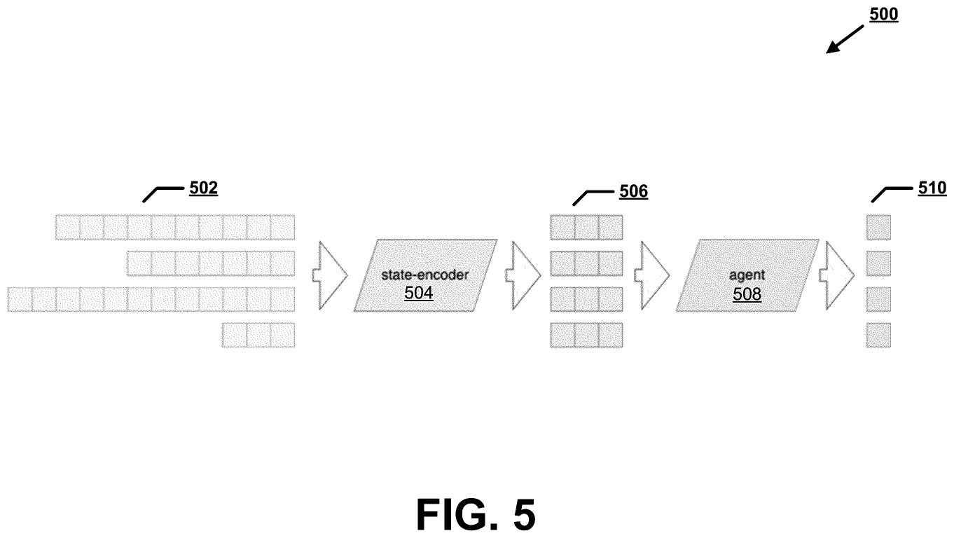

In some embodiments, the disclosed predictive machine learning model framework has an architecture as depicted in FIG. 5. As further depicted in FIG. 5, the predictive machine learning model framework 500 comprises a state encoder machine learning model 504 and a predictive software agent machine learning model 508. Historical event sequence data 502 may comprise data elements comprising state representation data, agent action data, and agent interaction data associated with a target one of client computing entities 102 for a predetermined time period (e.g., x number of days). As depicted in FIG. 5, the data elements of historical event sequence data 502 may comprise various lengths. State encoder machine learning model 504 may receive the historical event sequence data 502 and transforms each of the data elements in historical event sequence data 502 into sequence embeddings 506 comprising a fixed length. Predictive software agent machine learning model 508 may use the sequence embeddings 506 and generate a prediction of one or more optimal agent actions 510.

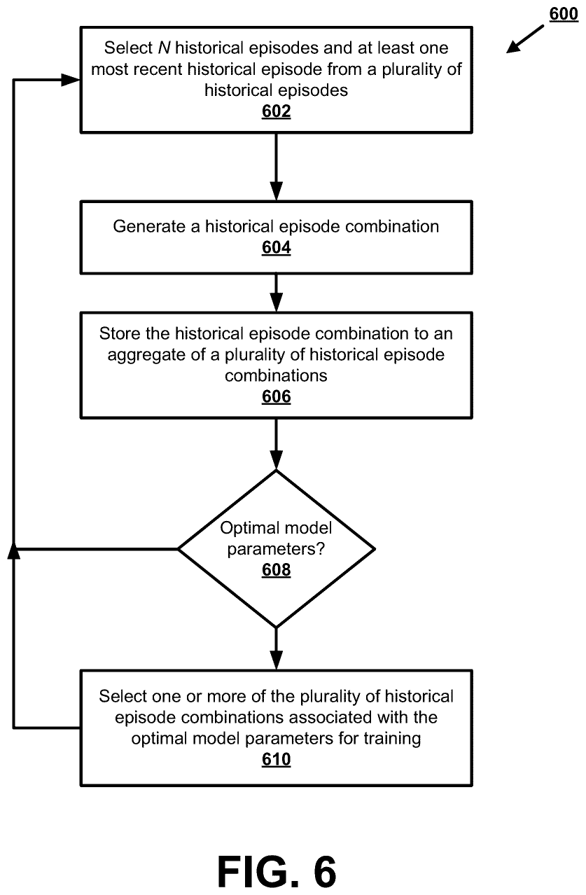

FIG. 6 is a flowchart diagram of an example process 600 for training a predictive software agent machine learning model. A training interval for training a predictive software agent machine learning model may comprise various steps/operations of the process 600. In some embodiments, the predictive data analysis computing entity 106 may periodically perform process 600 over one or more training intervals. A training interval may comprise a period over which a predictive software agent system 101 interacts with client computing entities 102 and logs data. At the end of each training interval, a predictive software agent machine learning model may be trained and re-deployed.

In some embodiments, a training interval the process 600 begins at step/operation 602 when the predictive data analysis computing entity 106 selects N historical episodes and at least one most recent historical episode selected from the plurality of historical episodes.

In some embodiments, at step/operation 604, the predictive data analysis computing entity 106 generates a historical episode combination. A historical episode combination may comprise N historical episodes selected (e.g., randomly) from the plurality of historical episodes that are combined with at least one most recent one of the plurality of historical episodes.

In some embodiments, at step/operation 606, the predictive data analysis computing entity 106 stores the historical episode combination. As an example, the historical episode combination may be stored to an aggregate of historical episode combinations in a database or cache. The historical episode combination may be stored for analysis, either individually, or as a collective whole, by predictive data analysis computing entity 106.

In some embodiments, at step/operation 608, the predictive data analysis computing entity 106 determines whether one or more of a plurality of historical episode combinations comprising at least the stored historical episode combination are associated with optimal model parameters. The optimal model parameters may be associated with a goal of the predictive software agent machine learning model. For example, the optimal model parameters may be based on a goal for maximizing reward values in determining agent actions to select for performance by predictive software agent system 101.

In some embodiments, at step/operation 610, if one or more of the plurality of historical episode combinations are associated with optimal model parameters, the predictive data analysis computing entity 106 selects the one or more of the plurality of historical episode combinations associated with the optimal model parameters for training of the predictive software agent machine learning model. The process 600 may be iteratively performed by returning to step/operation 602 after step/operation 610 or if one or more of the plurality of historical episode combinations are not determined to be associated with optimal model parameters at step/operation 608.

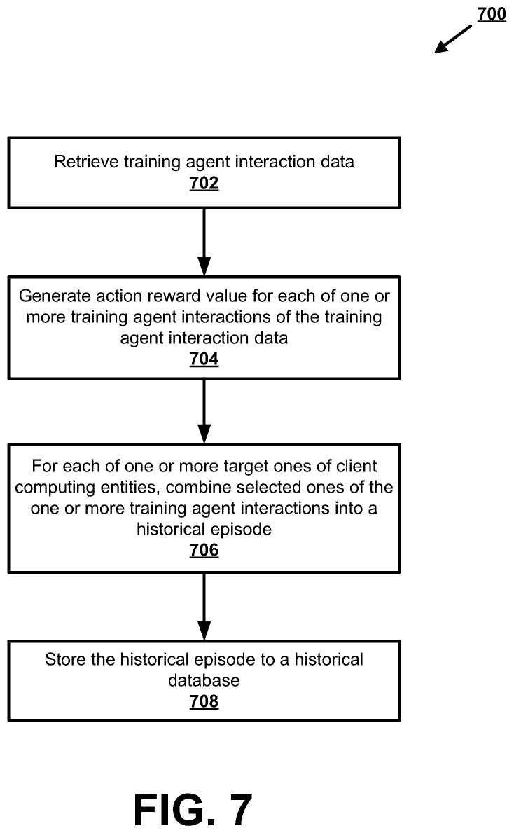

FIG. 7 is a flowchart diagram of an example process 700 for generating historical episodes.

In some embodiments, the process 700 begins at step/operation 702 when the predictive data analysis computing entity 106 retrieves training agent interaction data. The training agent interaction data may comprise one or more training agent interactions associated with respective one or more training agent actions. The training agent interaction data may be recorded over a selected period of time for a respective training interval.

In some embodiments, training agent interaction data describes one or more agent interactions, such as a transaction, activity, or communication between predictive software agent system 101 and a client computing entity 102 that is used to train a predictive software agent machine learning model. For example, a training agent interaction may comprise an action performed by a client computing entity 102 in response to an agent action during a selected period of time. Training agent interaction data may be collected over selected periods of time for respective training intervals.

In some embodiments, at step/operation 704, the predictive data analysis computing entity 106 generates an action reward value for each of one or more training agent interactions of the training agent interaction data by applying a reward function to the one or more training agent interactions.

In some embodiments, at step/operation 706, the predictive data analysis computing entity 106, for each of one or more target ones of client computing entities, combines selected ones of the one or more training agent interactions associated with a target client computing entity into a historical episode.

In some embodiments, at step/operation 708, the predictive data analysis computing entity 106 stores the historical episode to a historical database. The historical database may comprise a plurality of historical episodes.

Accordingly, as described above, various embodiments of the present disclosure make important technical contributions to improving predictive accuracy of a predictive software agent machine learning models comprising a reinforcement learning machine learning model by predicting optimal agent actions based on future discounted action reward values. This approach improves training speed and training efficiency of training predictive software agent machine learning models. It is well-understood in the relevant art that there is typically a tradeoff between predictive accuracy and training speed, such that it is trivial to improve training speed by reducing predictive accuracy. Thus the real challenge is to improve training speed without sacrificing predictive accuracy through innovative model architectures. Accordingly, techniques that improve predictive accuracy without harming training speed, such as the techniques described herein, enable improving training speed given a constant predictive accuracy. In doing so, the techniques described herein improve efficiency and speed of training predictive software agent machine learning models, thus reducing the number of computational operations needed and/or the amount of training data entries needed to train predictive software agent machine learning models. Accordingly, the techniques described herein improve the computational efficiency, storage-wise efficiency, and/or speed of training machine learning models.

### VI. CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation. It should be understood that the examples and embodiments in the Appendix are also for illustrative purposes and are non-limiting in nature. The contents of the Appendix are incorporated herein by reference in their entirety.

### VII. EXAMPLES

Example 1. A computer-implemented method comprising: receiving, by one or more processors, an agent action query comprising an entity identifier and one or more Boolean flags; receiving, by the one or more processors, historical event sequence data associated with the entity identifier, wherein the historical event sequence data comprises state representation data, agent action data, and agent interaction data; transforming, by the one or more processors and using a state encoder machine learning model, the historical event sequence data into one or more sequence embeddings comprising fixed-length vectors; generating, by the one or more processors and using a predictive software agent machine learning model, a prediction output comprising one or more optimal agent actions comprising at least a best agent action based on the one or more sequence embeddings and the one or more Boolean flags, wherein: (i) the best agent action comprises a highest-scoring action, (ii) the highest-scoring action is determined from an action distribution based on an action reward value associated with the highest-scoring action, (iii) the predictive software agent machine learning model is trained over one or more training intervals by: (a) retrieving training agent interaction data comprising one or more training agent interactions associated with respective one or more training agent actions, the training agent interaction data recorded over a selected period of time for a respective training interval, (b) generating an action reward value for each of the one or more training agent interactions by applying a reward function to the one or more training agent interactions, (c) for each of one or more target client computing entities, combining selected ones of the one or more training agent interactions associated with the entity into a historical episode, (d) storing the historical episode to a historical database comprising a plurality of historical episodes, (e) generating a plurality of historical episode combinations, each of the plurality of historical episode combinations comprising N historical episodes and at least one most recent historical episode selected from the plurality of historical episodes, and (f) determining one or more of the plurality of historical episode combinations associated with optimal model parameters; and initiating, by the one or more processors, the performance of the one or more optimal agent actions.

Example 2. The computer-implemented method of any of the preceding examples, wherein the predictive software agent machine learning model comprises a reinforcement learning machine learning model.

Example 3. The computer-implemented method of any of the preceding examples further comprising: monitoring one or more agent interactions associated with the performance of the one or more prediction-based actions; and generating the training agent interaction data based on the monitored one or more agent interactions.

Example 4. The computer-implemented method of any of the preceding examples further comprising: filtering agent actions from the action distribution based on the Boolean flags.

Example 5. The computer-implemented method of any of the preceding examples, wherein transforming the state representation into one or more sequence embeddings further comprises: tokenizing the historical event sequence data; and normalizing the tokenized historical event sequence data into the fixed-length vectors.

Example 6. The computer-implemented method of any of the preceding examples, wherein the action distribution comprises a set of one or more agent actions associated with respective action reward values.

Example 7. The computer-implemented method of any of the preceding examples, wherein the predictive software agent machine learning model comprises a deep Q network.

Example 8. The computer-implemented method of any of the preceding examples, wherein the deep Q network comprises an exploration phase and an exploitation phase.

Example 9. A computing apparatus comprising memory and one or more processors communicatively coupled to the memory, the one or more processors configured to: receive an agent action query comprising an entity identifier and one or more Boolean flags; receive historical event sequence data associated with the entity identifier, wherein the historical event sequence data comprises state representation data, agent action data, and agent interaction data; transform, using a state encoder machine learning model, the historical event sequence data into one or more sequence embeddings comprising fixed-length vectors; generate, using a predictive software agent machine learning model, a prediction output comprising one or more optimal agent actions comprising at least a best agent action based on the one or more sequence embeddings and the one or more Boolean flags, wherein: (i) the best agent action comprises a highest-scoring action, (ii) the highest-scoring action is determined from an action distribution based on an action reward value associated with the highest-scoring action, (iii) the predictive software agent machine learning model is trained over one or more training intervals by: (a) retrieving training agent interaction data comprising one or more training agent interactions associated with respective one or more training agent actions, the training agent interaction data recorded over a selected period of time for a respective training interval, (b) generating an action reward value for each of the one or more training agent interactions by applying a reward function to the one or more training agent interactions, (c) for each of one or more target client computing entities, combining selected ones of the one or more training agent interactions associated with the entity into a historical episode, (d) storing the historical episode to a historical database comprising a plurality of historical episodes, (e) generating a plurality of historical episode combinations, each of the plurality of historical episode combinations comprising N historical episodes and at least one most recent historical episode selected from the plurality of historical episodes, and (f) determining one or more of the plurality of historical episode combinations associated with optimal model parameters; and initiate the performance of the one or more optimal agent actions.

Example 10. The computing apparatus of any of the preceding examples, wherein the predictive software agent machine learning model comprises a reinforcement learning machine learning model.

Example 11. The computing apparatus of any of the preceding examples, wherein the one or more processors are further configured to: monitor one or more agent interactions associated with the performance of the one or more prediction-based actions; and generate the training agent interaction data based on the monitored one or more agent interactions.

Example 12. The computing apparatus of any of the preceding examples, wherein the one or more processors are further configured to: tokenize the historical event sequence data; and normalize the tokenized historical event sequence data into the fixed-length vectors.

Example 13. The computing apparatus of any of the preceding examples, wherein the action distribution comprises a set of one or more agent actions associated with respective action reward values.

Example 14. The computing apparatus of any of the preceding examples, wherein the predictive software agent machine learning model comprises a deep Q network.

Example 15. The computing apparatus of any of the preceding examples, wherein the deep Q network comprises an exploration phase and an exploitation phase.

Example 16. One or more non-transitory computer-readable storage media including instructions that, when executed by one or more processors, cause the one or more processors to: receive an agent action query comprising an entity identifier and one or more Boolean flags; receive historical event sequence data associated with the entity identifier, wherein the historical event sequence data comprises state representation data, agent action data, and agent interaction data; transform, using a state encoder machine learning model, the historical event sequence data into one or more sequence embeddings comprising fixed-length vectors; generate, using a predictive software agent machine learning model, a prediction output comprising one or more optimal agent actions comprising at least a best agent action based on the one or more sequence embeddings and the one or more Boolean flags, wherein: (i) the best agent action comprises a highest-scoring action, (ii) the highest-scoring action is determined from an action distribution based on an action reward value associated with the highest-scoring action, (iii) the predictive software agent machine learning model is trained over one or more training intervals by: (a) retrieving training agent interaction data comprising one or more training agent interactions associated with respective one or more training agent actions, the training agent interaction data recorded over a selected period of time for a respective training interval, (b) generating an action reward value for each of the one or more training agent interactions by applying a reward function to the one or more training agent interactions, (c) for each of one or more target client computing entities, combining selected ones of the one or more training agent interactions associated with the entity into a historical episode, (d) storing the historical episode to a historical database comprising a plurality of historical episodes, (e) generating a plurality of historical episode combinations, each of the plurality of historical episode combinations comprising N historical episodes and at least one most recent historical episode selected from the plurality of historical episodes, and (f) determining one or more of the plurality of historical episode combinations associated with optimal model parameters; and initiate the performance of the one or more optimal agent actions.

Example 17. The computer program product of any of the preceding examples further comprising instructions that cause the computing apparatus to: monitor one or more agent interactions associated with the performance of the one or more prediction-based actions; and generate the training agent interaction data based on the monitored one or more agent interactions.

Example 18. The computer program product of any of the preceding examples further comprising instructions that cause the computing apparatus to: tokenize the historical event sequence data; and normalize the tokenized historical event sequence data into the fixed-length vectors.

Example 19. The computer program product of any of examples 16 through 18, wherein the predictive software agent machine learning model comprises a deep Q network.

Example 20. The computer program product of example 19, wherein the deep Q network comprises an exploration phase and an exploitation phase.

APPENDIX
Algoritlun 1 Deep Q-learning with Experience Repay

```
  Initialize replay memory [symbol]    to capacity [symbol]
  Initialize action-value function [symbol]    with random weights
  for episode - 1, M do
    Initialize sequence s₁ = {rᵢ} and preprocessed sequenced
    ϕᵢ = ϕ(s₁)
    for i = 1, T do
      With probability ϵ select a random action aᵢ
      otherwise select aᵢ = maxₙ [symbol] *(ϕ(sᵢ), a; θ)
      Execute action aᵢ in emulator and observe reward rᵢ and
      image rᵢ₊₃
      Set rᵢ₊₁ = sₜ, nₜ, xᵢ₊₁ and preprocess ϕₜ₊₁ = ϕ(sₜ₊₁)
      Store transition (ϕᵢ, aₜ, rᵢ, ϕₜ₊₁) in [symbol]
      Sample random minibatch of transitions (ϕⱼ, aⱼ, rⱼ, ϕⱼ₊₁) from [symbol]
      $Set {y}_{j} = \{ \begin{matrix}{r}_{j} & for terminal {ϕ}_{j + 1} \\ {r}_{j} + γ {max}_{a} , Q ( {ϕ}_{j + 1} , {a}^{′} ; θ ) & for non - terminal {ϕ}_{j + 1}\end{matrix}$
      Perform a gradient descent step on (yⱼ − [symbol]   (ϕⱼ, aⱼ; θ))²
      according to equation 3
    end for
  end for
```

1. A computer-implemented method comprising:
receiving, by one or more processors, an agent action query comprising an entity identifier and one or more Boolean flags;
receiving, by the one or more processors, historical event sequence data associated with the entity identifier, wherein the historical event sequence data comprises state representation data, agent action data, and agent interaction data;
transforming, by the one or more processors and using a state encoder machine learning model, the historical event sequence data into one or more sequence embeddings comprising fixed-length vectors;
generating, by the one or more processors and using a predictive software agent machine learning model, a prediction output comprising one or more optimal agent actions comprising at least a best agent action based on the one or more sequence embeddings and the one or more Boolean flags, wherein: (i) the best agent action comprises a highest-scoring action, (ii) the highest-scoring action is determined from an action distribution based on an action reward value associated with the highest-scoring action, (iii) the predictive software agent machine learning model is trained over one or more training intervals by:
(a) retrieving training agent interaction data comprising one or more training agent interactions associated with respective one or more training agent actions, the training agent interaction data recorded over a selected period of time for a respective training interval,
(b) generating an action reward value for each of the one or more training agent interactions by applying a reward function to the one or more training agent interactions,
(c) for each of one or more target client computing entities, combining selected ones of the one or more training agent interactions associated with the entity into a historical episode,
(d) storing the historical episode to a historical database comprising a plurality of historical episodes,
(e) generating a plurality of historical episode combinations, each of the plurality of historical episode combinations comprising N historical episodes and at least one most recent historical episode selected from the plurality of historical episodes, and
(f) determining one or more of the plurality of historical episode combinations associated with optimal model parameters; and
initiating, by the one or more processors, the performance of the one or more optimal agent actions.

2. The computer-implemented method of claim 1, wherein the predictive software agent machine learning model comprises a reinforcement learning machine learning model.

3. The computer-implemented method of claim 1 further comprising:
monitoring one or more agent interactions associated with the performance of the one or more prediction-based actions; and
generating the training agent interaction data based on the monitored one or more agent interactions.

4. The computer-implemented method of claim 1 further comprising:
filtering agent actions from the action distribution based on the Boolean flags.

5. The computer-implemented method of claim 1, wherein transforming the state representation into one or more sequence embeddings further comprises:
tokenizing the historical event sequence data; and
normalizing the tokenized historical event sequence data into the fixed-length vectors.

6. The computer-implemented method of claim 1, wherein the action distribution comprises a set of one or more agent actions associated with respective action reward values.

7. The computer-implemented method of claim 1, wherein the predictive software agent machine learning model comprises a deep Q network.

8. The computer-implemented method of claim 6, wherein the deep Q network comprises an exploration phase and an exploitation phase.

9. A computing apparatus comprising memory and one or more processors communicatively coupled to the memory, the one or more processors configured to:
receive an agent action query comprising an entity identifier and one or more Boolean flags;
receive historical event sequence data associated with the entity identifier, wherein the historical event sequence data comprises state representation data, agent action data, and agent interaction data;
transform, using a state encoder machine learning model, the historical event sequence data into one or more sequence embeddings comprising fixed-length vectors;
generate, using a predictive software agent machine learning model, a prediction output comprising one or more optimal agent actions comprising at least a best agent action based on the one or more sequence embeddings and the one or more Boolean flags, wherein: (i) the best agent action comprises a highest-scoring action, (ii) the highest-scoring action is determined from an action distribution based on an action reward value associated with the highest-scoring action, (iii) the predictive software agent machine learning model is trained over one or more training intervals by:
(a) retrieving training agent interaction data comprising one or more training agent interactions associated with respective one or more training agent actions, the training agent interaction data recorded over a selected period of time for a respective training interval,
(b) generating an action reward value for each of the one or more training agent interactions by applying a reward function to the one or more training agent interactions,
(c) for each of one or more target client computing entities, combining selected ones of the one or more training agent interactions associated with the entity into a historical episode,
(d) storing the historical episode to a historical database comprising a plurality of historical episodes,
(e) generating a plurality of historical episode combinations, each of the plurality of historical episode combinations comprising N historical episodes and at least one most recent historical episode selected from the plurality of historical episodes, and
(f) determining one or more of the plurality of historical episode combinations associated with optimal model parameters; and
initiate the performance of the one or more optimal agent actions.

10. The computing apparatus of claim 9, wherein the predictive software agent machine learning model comprises a reinforcement learning machine learning model.

11. The computing apparatus of claim 9, wherein the one or more processors are further configured to:
monitor one or more agent interactions associated with the performance of the one or more prediction-based actions; and
generate the training agent interaction data based on the monitored one or more agent interactions.

12. The computing apparatus of claim 9, wherein the one or more processors are further configured to:
tokenize the historical event sequence data; and
normalize the tokenized historical event sequence data into the fixed-length vectors.

13. The computing apparatus of claim 9, wherein the action distribution comprises a set of one or more agent actions associated with respective action reward values.

14. The computing apparatus of claim 9, wherein the predictive software agent machine learning model comprises a deep Q network.

15. The computing apparatus of claim 14, wherein the deep Q network comprises an exploration phase and an exploitation phase.

16. One or more non-transitory computer-readable storage media including instructions that, when executed by one or more processors, cause the one or more processors to:
receive an agent action query comprising an entity identifier and one or more Boolean flags;
receive historical event sequence data associated with the entity identifier, wherein the historical event sequence data comprises state representation data, agent action data, and agent interaction data;
transform, using a state encoder machine learning model, the historical event sequence data into one or more sequence embeddings comprising fixed-length vectors;
generate, using a predictive software agent machine learning model, a prediction output comprising one or more optimal agent actions comprising at least a best agent action based on the one or more sequence embeddings and the one or more Boolean flags, wherein: (i) the best agent action comprises a highest-scoring action, (ii) the highest-scoring action is determined from an action distribution based on an action reward value associated with the highest-scoring action, (iii) the predictive software agent machine learning model is trained over one or more training intervals by:
(a) retrieving training agent interaction data comprising one or more training agent interactions associated with respective one or more training agent actions, the training agent interaction data recorded over a selected period of time for a respective training interval,
(b) generating an action reward value for each of the one or more training agent interactions by applying a reward function to the one or more training agent interactions,
(c) for each of one or more target client computing entities, combining selected ones of the one or more training agent interactions associated with the entity into a historical episode,
(d) storing the historical episode to a historical database comprising a plurality of historical episodes,
(e) generating a plurality of historical episode combinations, each of the plurality of historical episode combinations comprising N historical episodes and at least one most recent historical episode selected from the plurality of historical episodes, and
(f) determining one or more of the plurality of historical episode combinations associated with optimal model parameters; and
initiate the performance of the one or more optimal agent actions.

17. The one or more non-transitory computer-readable storage media of claim 16, wherein the instructions further cause the one or more processors to:
monitor one or more agent interactions associated with the performance of the one or more prediction-based actions; and
generate the training agent interaction data based on the monitored one or more agent interactions.

18. The one or more non-transitory computer-readable storage media of claim 16, wherein the instructions further cause the one or more processors to:
tokenize the historical event sequence data; and
normalize the tokenized historical event sequence data into the fixed-length vectors.

19. The one or more non-transitory computer-readable storage media of claim 16, wherein the predictive software agent machine learning model comprises a deep Q network.

20. The one or more non-transitory computer-readable storage media of claim 19, wherein the deep Q network comprises an exploration phase and an exploitation phase.
